(19) United States
(12) Patent Application Publication
(10) Pub. No.: US 2011/0227720 A1
(43) Pub. Date: Sep. 22, 2011

(54) COOPERATED FILTERING WITH REAL TIME AND NON-REAL TIME SYSTEM

(75) Inventors: Koki NAKASHIRO, Atsugi (JP); Yukio Ogawa, Tokyo (JP)

(73) Assignee: Hitachi, Ltd.

(21) Appl. No.: 13/051,990

(22) Filed: Mar. 18, 2011

(30) Foreign Application Priority Data
Mar. 19, 2010 (JP) 2010-064341

(51) Int. Cl. G08B 1/00

(52) U.S. Cl. 340/531

(57) ABSTRACT

To separate a module as a description of a service from another that gains access to sensors and actuators used in the module. The present invention provides cooperated filtering with realtime and non-realtime system including a realtime system to which sensors and actuators are coupled and a non-realtime system coupled to a network, wherein processes to determine operations by the non-realtime system or the realtime system are performed by each of input processing units that process input information from the sensors coupled to the realtime system, service processing units that determine operations of the actuators on the basis of data initialized by the non-realtime system, and output processing units that prepare data used for operating the actuators.

### INCORPORATION BY REFERENCE

This application claims priority based on a Japanese patent application, No. 2010-064341 filed on Mar. 19, 2010, the entire contents of which are incorporated herein by reference.

### BACKGROUND

The present invention relates to a network device system used for a network such as the Internet, and particularly to a technique of allowing a network device system to operate while being coupled to monitoring systems and controlling systems such as sensors and actuators.

Real world information processing systems that execute processes by collecting information from the real world to provide services to users have been configured using information devices owned by service providers. However, costs incurred in managing information devices such as servers become a heavy burden on service providers, and a cloud system has appeared to provide services to users over networks instead of the information devices of the service providers. In the cloud system, information from the real world is transmitted to a data center, and the information is accumulated and processed by the data center to extract advanced semantic information. Then, the result is fed back to the real world. The information passes through a plurality of network devices in a network that is led to the data center, and thus process delay occurs by a few seconds before feedback. Therefore, in services (plant control, financial algorithm transactions, preventive maintenance, and the like) requiring realtime response, process delay needs to be shortened while securing reliability. Further, it is expected that sensors will be widely used in various fields in the future and the amount of information from the real world will be increased. Thus, minimizing a rapid increase in power consumption along with an increase in the amount of information is a major issue.

Japanese Patent No. 3738802 discloses an information processing system in which one of a hardware module realized using FPGA (Field Programmable Gate Array) and a software module executed by a CPU can be selected for execution at a transfer speed.

### SUMMARY

In the above-described method, a module as a description of a service cannot be separated from another that gains access to sensors and actuators used in the module. In the case of running software when data requested by the module is large in size and in the case of changing an access method to sensors and actuators to be called, it is difficult to change the access method to be applied to other sensors and actuators having the same functions. Thus, the module itself needs to be changed, and the management of the module becomes complicated.

Cooperated filtering with realtime and non-realtime system disclosed in the specification includes a realtime system to which sensors and actuators are coupled and a non-realtime system coupled to a network, and processes to determine operations by the non-realtime system or the realtime system are performed by each of input processing units that process input information from the sensors coupled to the realtime system, service processing units that determine operations of the actuators on the basis of data initialized by the non-realtime system, and output processing units that prepare data used for operating the actuators.

In another aspect, the respective processing units may be installed in any one of the realtime system and the non-realtime system of the network device.

In still another aspect, the plurality of sensors and actuators may be handled as one unit.

In still another aspect, a method of input/output processes may be changed from a high-level node or in accordance with the load statuses of local network devices.

According to the teaching herein, functions of data extraction from the sensors and driving the actuators are separated from the modules, so that it is not necessary to change the modules even when the sensors and actuators are changed, thus improving the availability of the modules.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a diagram for exemplifying a configuration of cooperated filtering with realtime and non-realtime system of a first embodiment;

FIG. 2 is a diagram for exemplifying details of a part of the cooperated filtering with realtime and non-realtime system;

FIG. 3 is an example of a service request table;

FIG. 4 is an example of a non-realtime load table;

FIG. 5 is an example of a realtime load table;

FIG. 6 is an example of a service description table;

FIG. 7A is an example of a processing flowchart of the cooperated filtering with realtime and non-realtime system;

FIG. 7B is an example of a processing flowchart of the cooperated filtering with realtime and non-realtime system;

FIG. 8 is a diagram for exemplifying a configuration of cooperated filtering with realtime and non-realtime system of a second embodiment;

FIG. 9 is an example of a processing flowchart of preparing the service request table;

FIG. 10 is an example of a processing flowchart of a non-realtime load acquisition unit and a realtime load acquisition unit; and

FIG. 11 is an example of a data table for a high-level service description node.

### DETAILED DESCRIPTION OF THE EMBODIMENTS

Hereinafter, first to fourth embodiments of the present invention will be described.

### First Embodiment

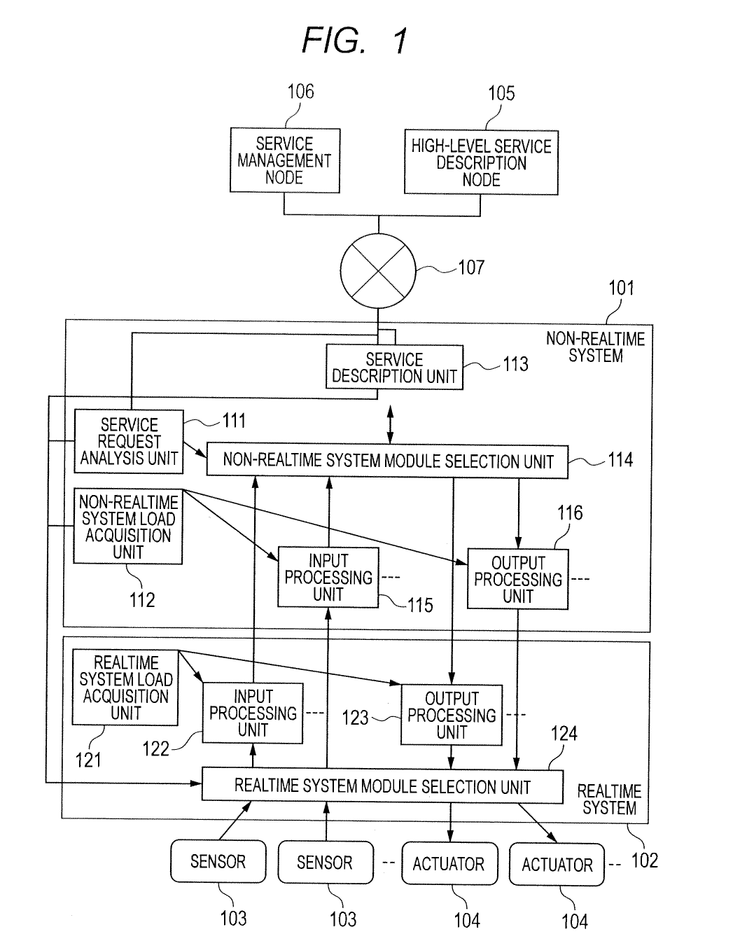

FIG. 1 is a block diagram for showing a configuration of cooperated filtering with realtime and non-realtime system of the embodiment. The cooperated filtering with realtime and non-realtime system of the embodiment includes network devices configured using one or more network device non-realtime systems 101, one or more network device realtime systems 102 coupled to the non-realtime systems 101 in accordance with a standard such as PCI, and one or more sensors 103 and actuators 104 coupled to the realtime systems 102 in accordance with standards such as PCI, Ethernet (registered trademark), USB (Universal Serial Bus), and DIO (Digital I/O). The cooperated filtering with realtime and non-realtime system further includes a high-level service description node 105 and a service management node 106 which are coupled to the non-realtime system 101 through a network 107.

The network 107 between the high-level service description node 105 and the service management node 106 is a general communication path through which communication packets compliant with IP protocols are transferred, such as the Internet, Intranet, or a composite network thereof.

A realtime system module selection unit 124 determines which of the non-realtime system 101 and the realtime system 102 is to analyze information from the sensors 103, and the information is analyzed by an input processing unit 115 installed in the determined non-realtime system 101 or an input processing unit 122 installed in the determined realtime system 102. A non-realtime system module selection unit 114 receives the analysis result while confirming from which input processing unit the analysis result has been transmitted, and the analysis result is passed on to a service description unit 113. The service description unit 113 determines operation content of services on the basis of the analysis result. The non-realtime system module selection unit 114 determines which of an output processing unit 116 of the non-realtime system 101 and an output processing unit 123 of the realtime system 102 is to execute the operation content. The output processing unit 116 of the non-realtime system 101 or the output processing unit 123 of the realtime system 102 prepares data used for actually operating the actuators 104, and the realtime system module selection unit 124 receives the data while confirming from which output processing unit the analysis result has been transmitted. The data is passed on to the target actuator 104, and the content of the service description unit 113 is operated by activating the actuator 104. Further, the service description unit 113 can transmit or receive information again to/from the high-level service description node 105 via the network 107, so that the system can cooperate with other network devices.

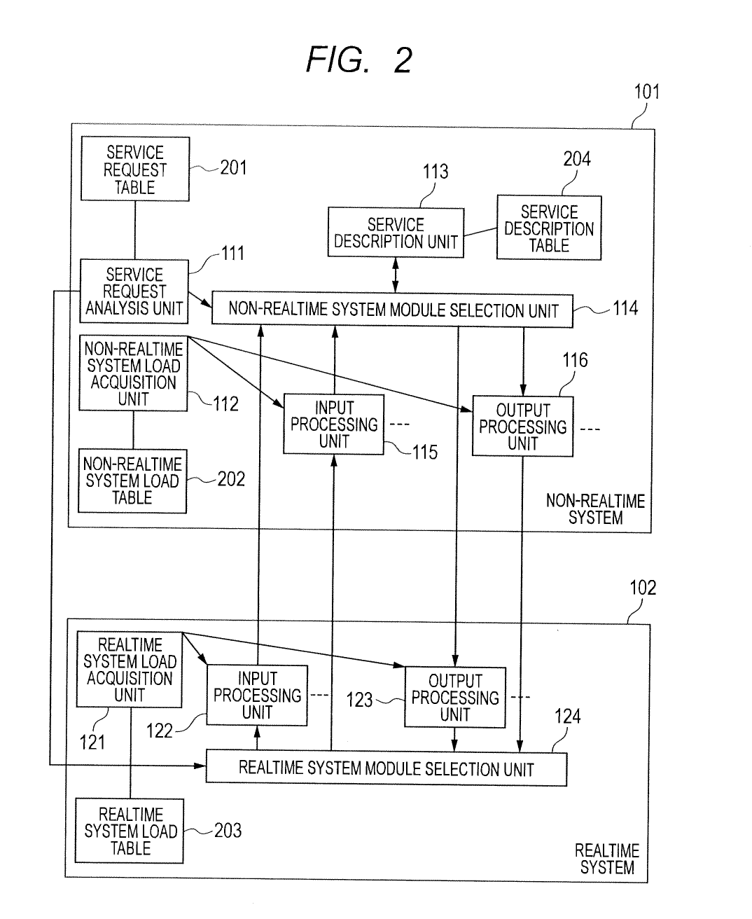

In FIG. 2, operations and configurations of the non-realtime system module selection unit 114, the realtime system module selection unit 124, a service request analysis unit 111, a non-realtime system load acquisition unit 112, and a realtime system load acquisition unit 121 shown in FIG. 1 will be described. The service request analysis unit 111 obtains, from the service management node 106, a request level in accordance with each service description described in a service description table 204 which is held by the service description unit 113 and in which each service content is described, and inputs the request level to the non-realtime system module selection unit 114 and the realtime system module selection unit 124. In addition, the service request analysis unit 111 determines which of the input processing unit 115 of the non-realtime system 101 and the input processing unit 122 of the realtime system 102 is to be used and which of the output processing unit 116 of the non-realtime system 101 and the output processing unit 123 of the realtime system 102 is to be used.

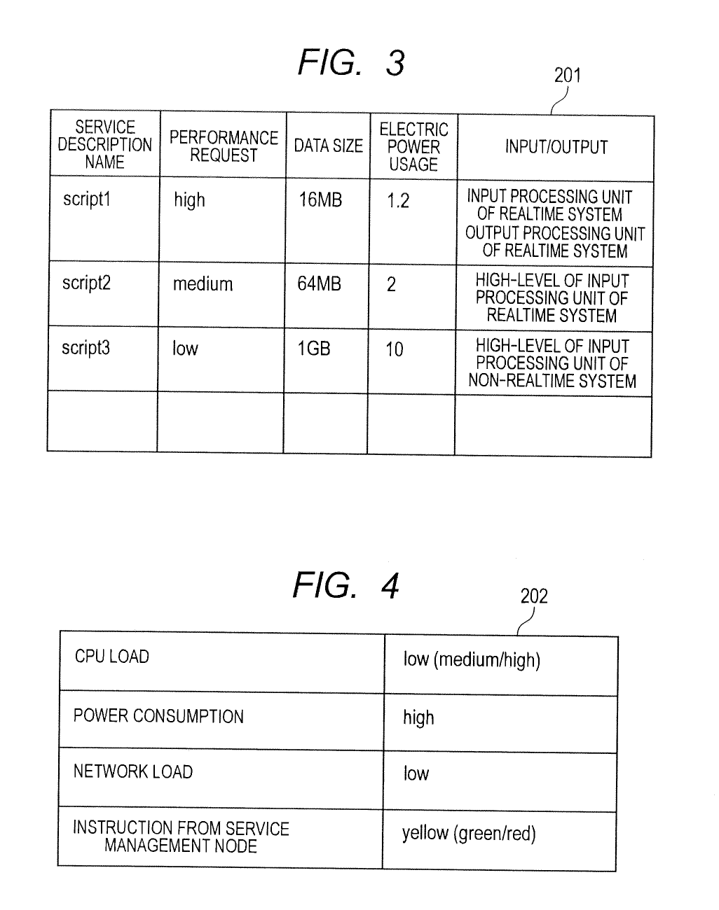

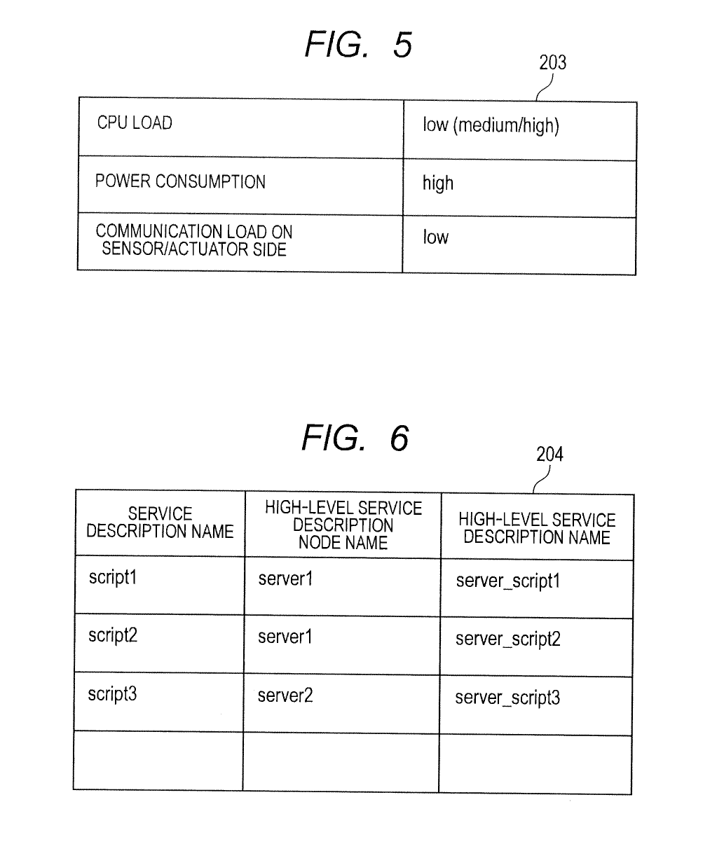

FIG. 3 shows a configuration of a service request table 201. FIG. 4 shows a configuration of a non-realtime system load table 202. FIG. 5 shows a configuration of a realtime system load table 203. FIG. 6 shows a configuration of a service description table 204.

The service request table 201 shown in FIG. 3 includes items of a service description name, a performance request, a data size, electric power usage, and an input/output type. The non-realtime system load table 202 shown in FIG. 4 includes items related to the load on the non-realtime system 101, such as a CPU load, power consumption, a network load, and an instruction from the service management node. The realtime system load table 203 shown in FIG. 5 includes items related to the load on the realtime system 102, such as a CPU load, power consumption, and a communication load on the sensor/actuator side. The service description table 204 shown in FIG. 6 includes items of a service description name, a high-level service description node name, and a high-level service description name.

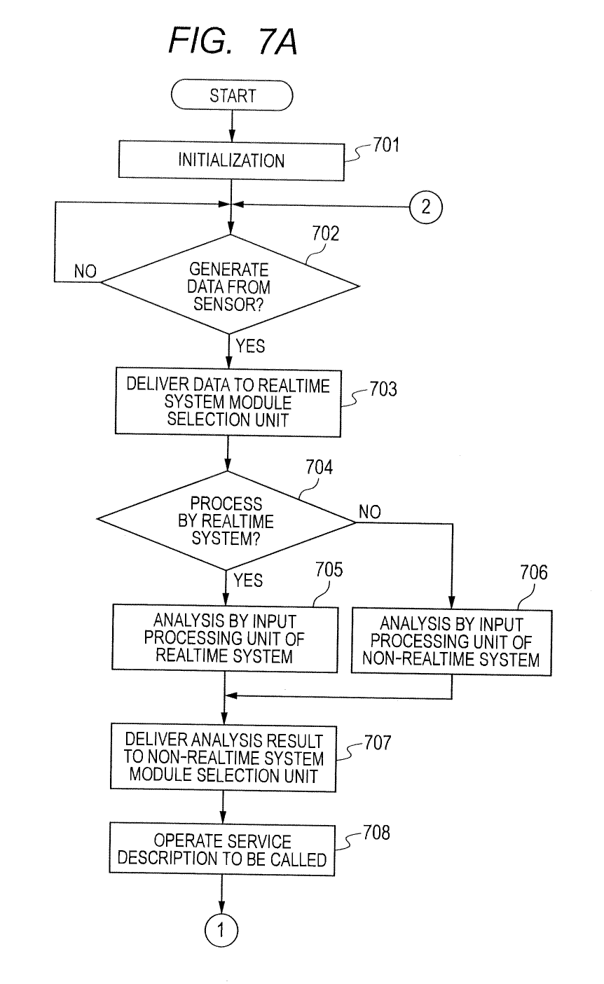

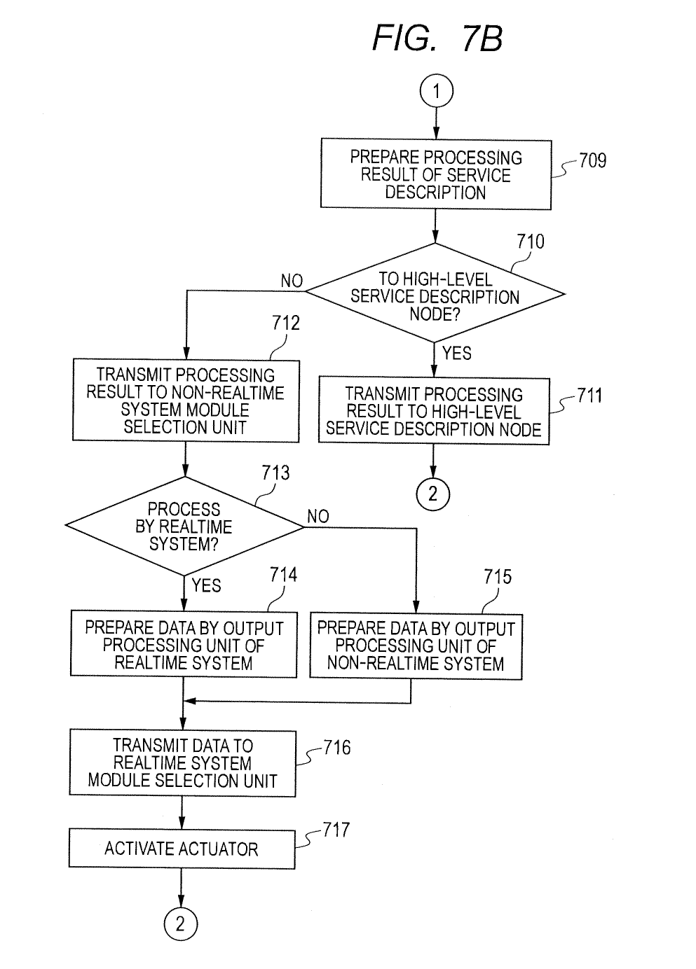

FIG. 7A is a flowchart of processes executed by the cooperated filtering with realtime and non-realtime system. In the first place, a service description name, a high-level service description node name, and a high-level service description name to call the system are registered to the service description table 204 in the non-realtime system 101 by the service management node 106 or directly by an administrator. In addition, a script or a binary execution program that is the body of the service description is installed in the non-realtime system 101. Further, the service request table 201 is set by the service management node 106 or directly by an administrator to determine which service description is to be executed by the input processing unit 115 of the non-realtime system 101 or the input processing unit 122 of the realtime system 102 for each sensor (701). Next, the system waits for data necessary for each service description from the sensors 103 (702). When receiving the data, the data is transmitted to the realtime system module selection unit 124 (703), and analyzed by the input processing unit 115 of the non-realtime system 101 or the input processing unit 122 of the realtime system 102 which is determined for each sensor in Step 701 (704). This analysis includes an average value computing process for data which is obtained from the plurality of sensors at the same time, an average value computing process for data which is obtained from a single sensor within a certain period of time, a maximum/minimum value computing process for data which is obtained from the plurality of sensors at the same time, a maximum/minimum value computing process for data which is obtained from a single sensor within a certain period of time, an abnormal value determination process for sensor data using a threshold value, an abnormal value determination process using the differential value, the integral value, and the like of sensor data, a frequency component computing process for sensor data by fast Fourier transformation, a sample decimation process in the temporal direction of sensed information, a quantization process (including reduction of the number of bits and data format conversion such as conversion from a double-precision number to an integral number) for sensed information, a combined packet generating process (one set of three kinds of pieces of information is converted to 32 bits) for a plurality of pieces of sensed information, a compression process (which is stipulated in, for example, RFC4944 (6lowPAN-HC-04) of the IETF standard) for header information, a frame decimation process for camera image information, an image size changing process for camera image information, and a feature extraction process such as face detection, motion detection and the like from camera image information (705 and 706). Next, the analysis result is transmitted to the non-realtime system module selection unit 114 (707), and the target service description is executed using the result (708).

The following steps will be described using FIG. 7B. Each result of the executed service descriptions is prepared by the service description unit 113 (709), it is confirmed using the service description itself whether or not the result is to be returned to the high-level service description node (710). In the case where the result is to be returned, the processing result is transmitted to the high-level service description node 105 (711), and the system waits for data from the sensors. In the case where the service description does not describe that the result is to be returned to the high-level service description node 105, but describes that the actuator 104 is to be activated, the processing result is transmitted to the non-realtime system module selection unit 114 (712). It is determined which of the output processing unit 123 of the realtime system 102 and the output processing unit 116 of the non-realtime system 101 is to be executed by referring to the service request table 201 (713). Data used for activating the target actuator is prepared on the basis of the processing result of the service description by the output processing unit 123 of the realtime system 102 or the output processing unit 116 of the non-realtime system 101 (714 and 715), and transmitted to the realtime system module selection unit 124 (716). The data is transmitted to the actuator 104 to activate (717). Thereafter, the system waits for inputs from the sensors 103 again. As described above, the service description is executed using the information from the sensors 103, and the result can be returned to the high-level service description node 105 or the actuator 104 can be activated.

### Second Embodiment

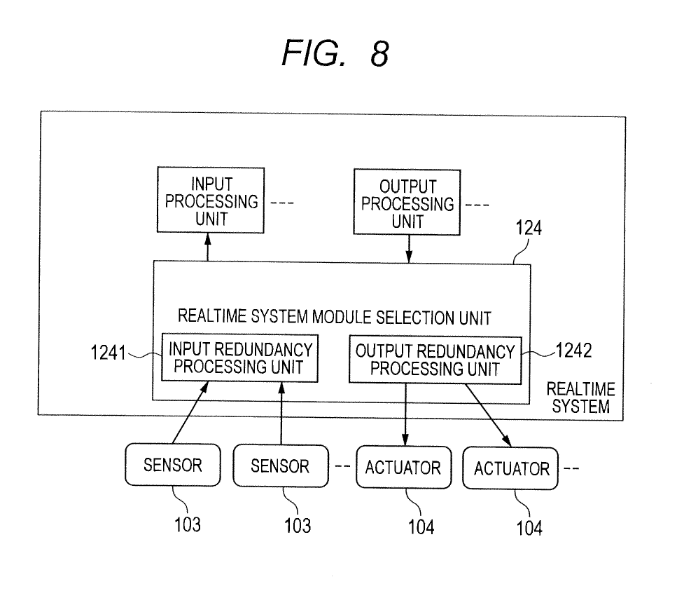

FIG. 8 is a block diagram for showing a configuration of cooperated filtering with realtime and non-realtime system of the embodiment. An input redundancy processing unit 1241 confirms inputs from the plurality of sensors and returns data to the input processing units 115 and 122 in a certain period of time even when some of data cannot be obtained. Accordingly, even when all data cannot be obtained due to failures of some sensors, the result can be returned to the high-level service description node 105 or the actuator 104 can be activated by executing the target service description. Further, one of the plurality of actuators which can be operated is selected and operated by an output redundancy processing unit 1242, so that the operation of the target actuator can be executed even when some actuators fail to operate.

### Third Embodiment

### Selection of Realtime System Or Non-Realtime System

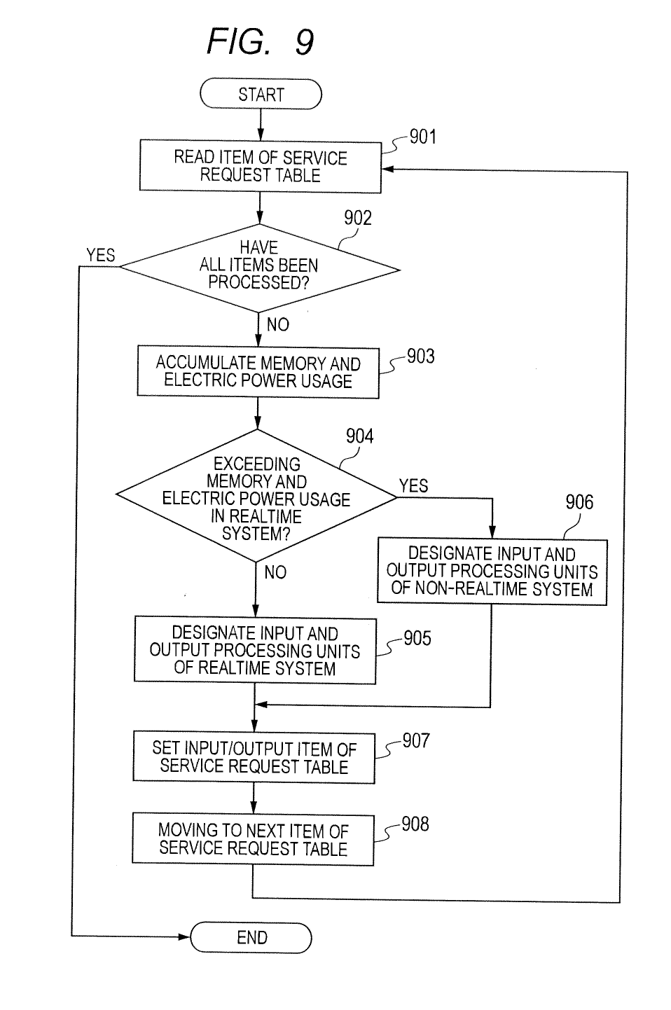

A method of preparing the service request table 201 will be described using FIG. 9. A performance, a necessary data size, and the value of electric power usage which are requested in the service description managed by the service management node are set to the service request table 201 used by the service request analysis unit 111 of FIG. 2 in the first embodiment. Next, the respective items of the service request table 201 are read (901), and the input and output processing units 122 and 123 of the realtime system are preferentially allocated (905 and 907) to the item in which the performance request is high and the data size is small within a range not exceeding a memory amount or electric power usage available for the realtime system (902, 903 and 904). In addition, the rest of the items are set so as to be executed by the input and output processing units 115 and 116 of the non-realtime system (906 and 907). The above-described processes are repeated for each item of the service request table 201 (908). Accordingly, the input and output processing units of the realtime system realized in an external device, or the input and output processing units of the non-realtime system can be selected for use by using parameters determined by the data size, the performance, and the electric power usage necessary for the service description.

### Fourth Embodiment

### Operation Change By Parameter

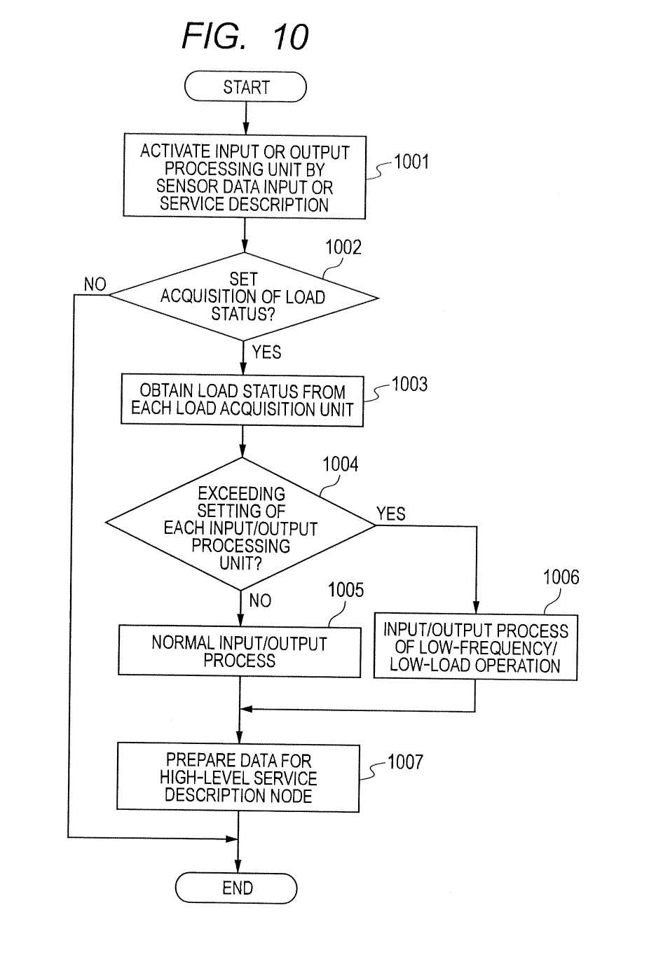

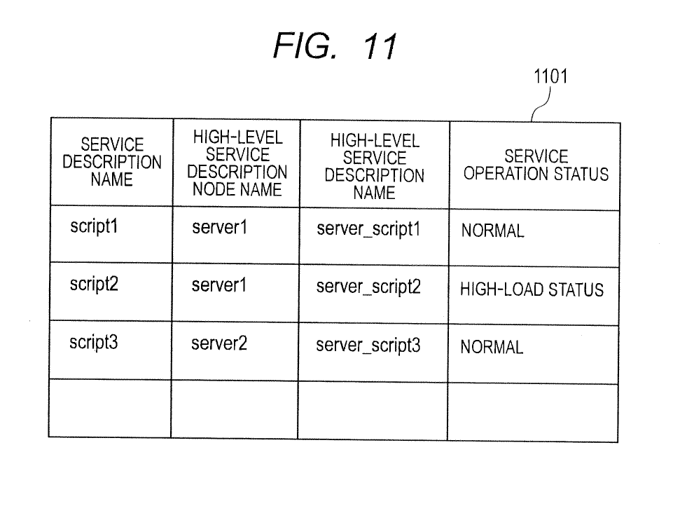

Operations of the non-realtime system load acquisition unit 112 and the realtime system load acquisition unit 121 of FIG. 2 will be described using FIG. 10. In the first place, data is input from the sensors or the service description is operated by the service description unit, so that the input processing unit or the output processing unit is activated (1001). Here, in the case where the respective input and output processing units are set to obtain load statuses (1002), the realtime system load acquisition unit 121 or the non-realtime system load acquisition unit 112 sets the load status to the realtime system load table 203 or the non-realtime system load table 202 (1003). Whether normal input and output processes are to be performed or a decimation operation process is to be performed in a high-load state is selected using parameters such as a CPU load, power consumption, a network load, and an instruction from the service management node in the non-realtime system, and using parameters such as a CPU load, power consumption, and a communication load on the sensor/actuator side in the realtime system on the basis of the settings of the respective input and output processing units (1004, 1005 and 1006). Next, the details of the operations executed by the system are added to analysis data after the input process, for the high-level service description node (1007). The added data is shown in a data table 1101 for the high-level service description node of FIG. 11. As described above, the processing content can be changed on the basis of the load status and power consumption of an external device or a computer in which the respective processing units are installed, and an instruction from a different computer coupled to the network of the computer.

According to the embodiments, functions of data extraction from the sensors and driving the actuators are separated from the modules, so that it is not necessary to change the modules even when the sensors and actuators are changed, thus improving the availability of the modules. Further, the sensors and actuators can be integrally operated. Thus, even when the sensors and actuators in a group are stopped due to failures, the operations can be continued using the rest of the sensors and actuators. Further, by providing load information to the function of access to the sensors, limited functions can be provided without stopping the system even in a high-load state. Whether an access function on hardware of FPGA or the like in which a data size is limited is used or an access function on software of a PC or the like is used can be determined in accordance with the data size of information necessary for access to the sensors and actuators requested by the modules, so that as many functions as possible can be realized on a device.

The specification and drawings are, accordingly, to be regarded in an illustrative rather than a restrictive sense. It will, however, be evident that various modifications and changes may be made thereto without departing from the spirit and scope of the invention(s) as set forth in the claims.

What is claimed is:

1. Cooperated filtering with realtime and non-realtime system comprising a realtime system to which sensors and actuators are coupled and a non-realtime system coupled to a network,
wherein processes to determine operations by the non-realtime system or the realtime system are performed by each of input processing units that process input information from the sensors coupled to the realtime system, service processing units that determine operations of the actuators on the basis of data initialized by the non-realtime system, and output processing units that prepare data used for operating the actuators.

2. The cooperated filtering with realtime and non-realtime system according to claim 1,
wherein there are provided redundancy processing units that perform the processes of the input processing units and the output processing units together.

3. The cooperated filtering with realtime and non-realtime system according to claim 1,
wherein there are provided module selection units that select which of a hardware input processing unit and a hardware output processing unit realized in the realtime system and a software input processing unit and a software output processing unit realized in the non-realtime system is to be used by using parameters determined on the basis of a data size, a performance, and electric power usage necessary for the service processing units.

4. The cooperated filtering with realtime and non-realtime system according to claim 3,
wherein there is provided a status notification unit that changes each processing content of the hardware input processing unit, the hardware output processing unit, the software input processing unit, and the software output processing unit on the basis of a load status and power consumption of the realtime system or the non-realtime system in which the processing units are installed and an instruction from another computer coupled to the network.
